(19) United States
(12) Patent Application Publication
(10) Pub. No.: US 2008/0073916 A1
(43) Pub. Date: Mar. 27, 2008

(54) Electromagnetic Lock with Strong Anti-impact Ability

(76) Inventor: Hao Min, Nanjing (CN)

Correspondence Address: GLOBAL IP SERVICES, 7285 W. Eagle Court, Winton, CA, 95388, US

(21) Appl. No.: 11/624,192

(22) Filed: Jan. 17, 2007

(30) Foreign Application Priority Data
Sep. 25, 2006 (CN) 200620077575.4

(51) Int. Cl. E05C 3/06

(52) U.S. Cl. 292/201

(57) ABSTRACT

The present invention resolves the problem that a lockpin is easy to broken in current electromagnetic lock, find a good structure for greatly improving the capability of the electromagnetic lock against a very strong impact from outside. The new structure can transfer the outside force to a reinforced rib on the lock shell. The new electromagnetic lock comprises a lock shell (1), an arc style bolt (2), an electromagnet (3), an implemental part (4) of the electromagnet (3) connecting with one end of the lockpin (5), a unlock slot (7) is on the lockpin (5), a slipping block (8) is installed in a slipping slot against the lockpin, other end of this slipping block is against the bolt tail (202) of the arc style bolt. A second spring (20) is installed between the bottom of the slipping slot and the slipping block (8), the second spring (20) forces the slipping block (8) to contact the bolt tail (202) of arc style bolt. The structure of the new electromagnetic lock is simple, the manufacturing process is easy, and the new electromagnetic lock can resist relatively stronger wallop.

### CROSS REFERENCE TO THE RELATED PATENT APPLICATION

This patent application claims the priority of the Chinese patent application No. 200620077575.4, filed on Sep. 25, 2006.

### FIELD OF THE INVENTION

This invention relates to a new style electromagnetic lock, which is sustainable a wallop over one ton.

### BACKGROUND OF THE INVENTION

Currently, safety boxes for banks, jewelry business, and firearms business etc., all use electromagnetic lock with fingerprint identification to achieve safety purpose, unauthorized users cannot open it with normal methods. Therefore, anti-impact-ability is a main concern for electromagnetic locks, which are required to suffer a wallop over one ton without any damage for a safety purpose.

Most electromagnetic locks in current market use electromagnet to open or close the lock. For example, when electromagnet is on power or off power, a lockpin can plug into or pull out from slipping block, which controls a bolt, to open or lock the electromagnetic lock.

Under this design, the electromagnetic lock can be opened without any password or key if the lockpin that connects the electromagnet and slipping block is destroyed.

However, consider that the relatively weakness of the electromagnet force and the gravitation acceleration of the bolt, the lockpin cannot be designed very strong. Therefore, the lockpin is easy broken. This is the main hidden trouble of the safety.

### SUMMARY OF THE INVENTION

The purpose of the present invention is to solve the problem of the weakness of the lockpins for current electromagnetic lock, to design a stronger electromagnetic lock, which can survive under very strong wallop, and can transfer the destroy power into a reinforced rib.

The technical scheme is that:

A kind of electromagnetic lock includes a lock shell, an arc style bolt, and an electromagnet. The arc style bolt is pivoted installed in the lock shell, and the head of bolt is outside of lock shell. The electromagnet is installed inside lock shell, the feature is an implemental part of the electromagnet is against one end of a lockpin, other end of the lockpin is against a third spring, the lockpin and the third spring are restricted in a slot on the lock shell. A slipping block is installed vertically with the lockpin, one end of the slipping block is against the lockpin, other end is against the bolt tail of the arc style bolt. The slipping block is installed in the slipping slot of the lock shell, a second spring is fixed between the bottom of the slipping slot and the slipping block and pushes the slipping block to touch the bolt tail.

The present invention also uses the following technologies:

There is a reinforced rib near the touch-point of the slipping block and the arc style bolt in the lock shell. A supporting block is vertical to the slipping block near the reinforced rib, one end of the supporting block is against the slipping block, another end is against a fourth spring which is against the lock shell.

The slipping block has an anti-impact-incline face near the touch-point of the slipping block with the arc style bolt, the reinforced rib has an impact-sustainable-incline which is opposite the anti-impact-incline.

The electromagnet uses permanent magnets to increase magnetic forces. The design also can increase third spring rate, thereby to get bigger lockpin.

The merits for the present invention:

1. This invention solves the problem of the weakness of electromagnetic locks in current market, the new electromagnetic locks can guarantee no any break or distortion under 1000 kg wallop. The safety grade is increased greatly.

2. This invention uses lever principle to reduce the force acting on lockpin, thereby the safety grade for the slipping block and lockpin is increased.

3. This invention simplifies the lock structure, and makes producing process easy.

### BRIEF DESCRIPTION OF THE DRAWINGS

FIG. 1 is a sketch figure to show the structure of the electromagnetic lock of the present invention under lock condition.

FIG. 2 is a sketch figure to show the structure of the electromagnetic lock of the present invention under unlock condition.

### DETAIL DESCRIPTION OF THE INVENTION

The accompanying drawings facilitate understanding of the various embodiments of this invention. In such drawings:

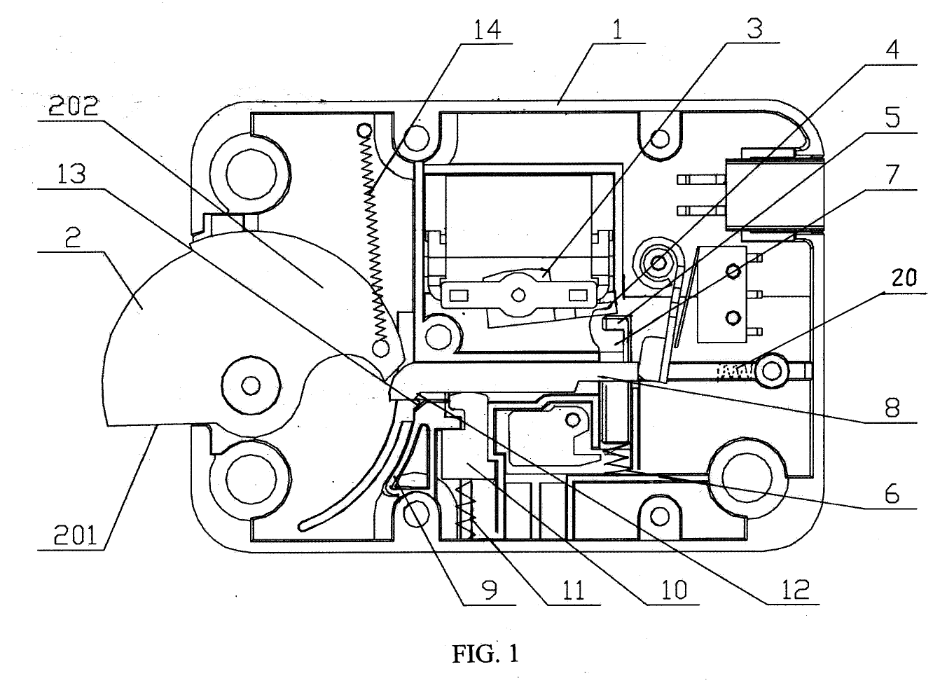

Refer to FIG. 1, it shows the body structure of an electromagnetic lock, which includes a lock shell (1), an arc style bolt (2), an electromagnet (3). The are style bolt (2) is pivoted assembled in the lock shell (1), the bolt head (201) of the arc style bolt (2) is outside of the lock shell (1), the bolt tail (202) of the arc style bolt (2) is located inside the lock shell (1) connected a first reposition spring (14), other end of which is fixed with the lock shell.

The electromagnet (3), which adapts permanent magnets, is installed inside the lock shell (1). An implemental part (4) (action like a lever structure) of the electromagnet (3) withstands one end of a lockpin (5), another end of the lockpin (5) touches with a third spring (6), the lockpin and third spring are restricted in a guide slot on the lock shell (1).

Also, there has a unlock slot (7) on the lockpin (5). A slipping block (8) is installed vertically with the lockpin, one end of the slipping block is against the lockpin (5), other end is against the bolt tail (202) of the arc style bolt. The slipping block is installed in the slipping slot of the lock shell (1), a second spring (20) is located between the bottom of the slipping slot and the slipping block and pushes the slipping block (8)to touch the lock end (202).

For increasing the anti-impact-ability, there is a reinforced rib (9) near the touch-point between the slipping block (8) and the arc style bolt (2). An anti-impact-incline (12) is designed on the slipping block (8), an impact-sustainable-incline (13) which is opposite anti-impact-incline (12) is designed on the reinforced rib (9), the angle for these anti-impact-incline (12) and impact-sustainable-incline (13) is 45 degree.

Under this design, outside force will follow the bolt head (201), bolt tail (202), reinforced rib (9) to the lock shell (1). Also, there has a pivot formed by the slipping block (8) and the supporting block (10) near reinforced rib (9). Using this pivot as support point, the torque force produced by the outside force slightly acts on the lockpin (5). Therefore, this structure guarantees the force acting on lockpin (5) will be decreased to a small force to protect it from break or distortion when the lock is suffered a heavy impact.

The supporting block (10) will always prop slipping block (8) under the force by the fourth spring (11), this will guarantee the end with inclined face of the slipping block (8) can move into the slot freely under normal unlocking condition. The width of the slot should widen a little bit than the width of slipping block (8).

In this invention, springs, electromagnet, switch, etc are all installed in corresponding slots or holes on the lock shell.

All other parts un-described herewith are common knowledge.

The working process for the electromagnetic lock with strong anti-impact ability of present invention:

FIG. 1 shows the lock under locking condition, the electromagnet (3) is off power, the slipping block (8) does not insert into the unlock slot (7) in the lockpin (5), thus the other end of the slipping block (8) protrudes out the slipping slot to withstand the bolt tail (202) of the arc style bolt (2). Thereby, the arc style bolt (2) becomes un-tunable.

Under a strong outside force, the force acting on bolt head (201) will transfer to the bolt tail (202) to push the slipping block (8). Thereafter, the slipping block (8) will swing a little bit around the supporting block (11) until the slipping block's (8) 45 degree inclined face touches with the 45 degree inclined face on the reinforced rib (9). Therefore, the outside force acting on the slipping block (8) will be transferred to the lock shell (1) through the reinforced rib (9). To design reinforced rib (9) correctly, lock can survive under very strong outside force because the force acting on the lockpin (5) is decreased tremendously. The anti-impact-ability of the electromagnetic lock is determined by the force acting on the reinforced rib. Through reasonable design, the reinforced rib can be strengthened.

In summery, the electromagnetic lock with strong anti-impact ability of present invention is an ideal design for against strong impact. This is the main different between the present invention and the prior art.

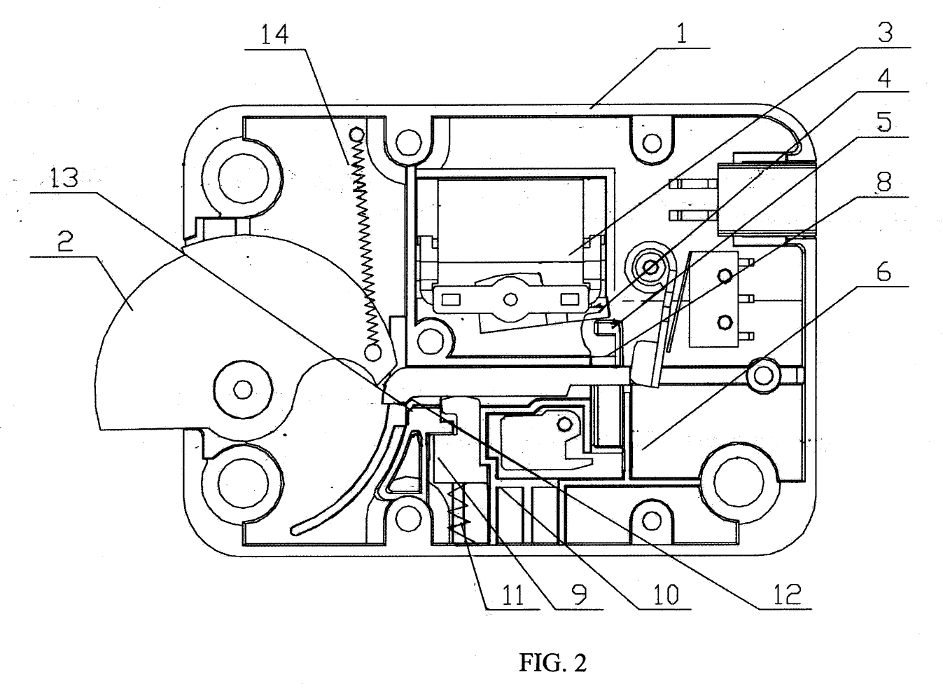

Now, refer the FIG. 2 to describe the procedure of unlocking the lock.

When electromagnet (3) is on power, the implemental part (4) pushes the lockpin (5) to make its unlock slot (7) and the slipping block (8) in alignment. At that time give arc style bolt (2) an outside force, this force is transferred to the slipping block (8) through the bolt tail (202), and overcome the force from the second spring (20) to make the slipping block (8) insert into the unlock slot (7). Since the end of slipping block (8) touching with the bolt tail (202) of arc style bolt (2) withdraws into the slide slot, the bolt tail (202) losses the support from the slipping block (8), the whole arc style bolt (2) can pivot a certain angle to open the lock.

After unlocking, the arc style bolt (2) returns to beginning status under the force of first restoration spring (14). At the same time, the slipping block (8) touches the jiggle switch installed in lock shell (1) to send out unlocking completed information to control system to fulfill all the unlocking procedure.

What is claimed is:

1. An electromagnetic lock with strong anti-impact ability comprising:
a lock shell, an arc style bolt, an electromagnet, a arc style bolt Pivoted installed in the lock shell, its bolt head being outside of the lock shell, the electromagnet being installed inside the lock shell;
a implemental part of the electromagnet being against one end of a lockpin, other end of the lockpin being against a third spring, the lockpin and the third spring being restricted in a slot on the lock shell;
a slipping block being installed inside a slipping slot of the lock shell and being vertical to the lockpin, two ends of the slipping block being against the lockpin and a bolt tail of the arc style bolt respectively;
a second spring located the end of the slipping slot, the second spring being against the slipping block to force it to contact the bolt tail of the arc style bolt.

2. The electromagnetic lock of claim 1, wherein further comprises a reinforced rib near a touch-point of the slipping block with the arc style bolt for resisting the impact from outside.

3. The electromagnetic lock of claim 1, wherein further comprises a supporting block for weakening the impact from outside to the lockpin, the supporting block is vertical to the slipping block and near the reinforced rib, two ends of the supporting block being respectively against the slipping block and a fourth spring based on the lock shell.

4. The electromagnetic lock of claim 2, wherein the slipping block has an anti-impact-incline near the touch-point of the slipping block and the arc style bolt, the reinforced rib has an impact-sustainable-incline being opposite to the anti-impact-incline.

5. The electromagnetic lock of claim 3, wherein the slipping block has an anti-impact-incline near the connection point of the slipping block and the arc style bolt, the reinforced rib has an impact-sustainable-incline being opposite to the anti-impact-incline.

6. The electromagnetic locks of claim 1, wherein magnets of the electromagnet are permanent magnets.
